(19) United States
(12) Patent Application Publication
(10) Pub. No.: US 2010/0081008 A1
(43) Pub. Date: Apr. 1, 2010

(54) Extruded Cross-Banded Magnesium Oxide Construction Board

(76) Inventor: Kathy Trout Trout, Anaheim, CA (US)

Correspondence Address: Law Office of Michael J. Feigin, 103 The Circle, (http://PatentLawNY.com), Passaic, NJ, 07055, US

(21) Appl. No.: 12/486,045

(22) Filed: Jun. 17, 2009

Related U.S. Application Data
(62) Division of application No. 12/239,854, filed on Sep. 29, 2008.

(51) Int. Cl. B32B 13/02; C04B 9/02; B32B 19/06; C04B 14/42

(52) U.S. Cl. 428/696; 106/801; 106/711; 156/346

(57) ABSTRACT

Embodiments of the invention comprise a method of making a construction board (also known as wallboard) and a device for making same. The resulting construction board is formed by mixing of at least magnesium oxide, magnesium chloride, and a binding agent into a slurry, adding particulized solid material while funneling the slurry, and extruding the slurry comprising the particulized solid material.

### BACKGROUND OF THE INVENTION

Commercial gypsum board panel products are the most popular interior finishing surfaces in homes today. Gypsum is used for its ability to be easily set in a desired form, along with its ability to retain chemically bound water and, therefore, to resist fire. Gypsum boards are made of a porous microcrystalline gypsum mineral “core” that contains cellular air voids, sometimes up to 50% by volume. These cellular air voids are processed into the core during manufacture by adding aqueous pre-generated chemical foam bubbles to a malleable or flowing slurry, such as a gypsum slurry, resulting in a light weight convenient panel product.

Building structures of the prior art have been fabricated using a variety of sheathing materials. Typical structural sheathing materials include plywood and orientated strand board, which are then covered with various exterior siding materials. Gypsum construction board or wallboard is used for interior surfaces and is generally satisfactory for that use; it has also been used for exterior fire protection. However, gypsum wallboard and the like are easily damaged by such as water, mold, fire, or even by day to day usage, for instance by playing children or by a doorknob or piece of furniture hitting into the board.

The method of manufacture of gypsum construction board in the prior art typically involves a process including mixing into a slurry calcium sulfate or calcium sulfate hemihydrate, water, a binding agent such as starch, and, in some cases, adding fibers and lower or upper sheets upon drying of the slurry. The slurry and sheets are typically passed through parallel upper and lower rollers via a conveyor belt system, and rolled for several minutes while the materials set into place. In prior art methods, the boards are placed into drying ovens or kilns for drying. Once the construction board has set sufficiently, or at some time before or during the setting process, the boards are cut to industry standards such as 4 feet wide by 8 to 12 feet long.

Numerous tests exist within the industry to determine the strength of wallboard. One such test is a “nail pull resistance” test. Wallboard is often installed by driving a nail, screw, or staple through the board and into a building structure. Such fastening devices tend to squash the wallboard and create a dimple in the surface of the construction board which is typically spackled over. The wallboard must further be strong enough to withstand not only nails and the like placed through it, but also to maintain structural integrity over long periods of time when used in buildings. This includes the supporting of loads placed upon the wallboard during its usage, including pictures, shelves, and the like, which are attached to the wallboard by nails and/or other fastening devices.

For example, according to ASTM (American Society for Testing and Materials) guidelines for magnesium oxide-based sheets with regard to nail pull resistance, “The substrate sheets shall have a minimum saturated nail-head pull-through resistance of 125 lbf (560 N) when tested in accordance with ASTM D 1037, utilizing a roofing nail with a 0.375-inch-diameter (10 mm) head and a shank diameter of 0.121 inch (3 mm). A minimum of 5 specimens shall be tested.” To date, no known prior art magnesium oxide construction board has passed this test. By and large, a weakness in prior art construction boards is that they structurally rely upon sheets of fiber glass netting. If a fastening device is inserted anywhere but dead center of the netting within the fiberglass, a nail may be pulled through the board itself.

Thus, there has been a long felt and unsolved need, as demonstrated, for example, by nail pull resistance tests designed by the ASTM and the failings of the prior art construction boards to withstand forces the boards are subjected to, to produce a construction board with significant strength to resist forces placed upon them during installation and regular usage.

### SUMMARY OF THE INVENTION

It is therefore an object of the invention to produce a construction board (wallboard) which is stronger, quicker to manufacture, and easier to produce than the prior art. It is also an object of the invention to develop a gypsum board capable of passing industry standard tests, e.g., the ASTM standards, including nail pull resistance tests.

It is a further object of the invention to place particulate matter, such as glass fibers, at regular intervals or injected on at least one side of a wallboard during production, so as to increase the strength of the construction board.

It is yet another object of the invention to develop a system for extruding slurry to form construction board.

It is yet another object of the invention to produce a magnesium oxide construction board with cross-banded fiber glass particles capable of increased resistance to nail pull, and to meet the requirements of the ASTM.

In a method of making construction board in an embodiment of the invention, magnesium oxide, magnesium chloride, and a binding agent are mixed into a slurry. Particulized solid material is added while funneling the slurry, and the slurry comprising the particulized solid material is extruded. In embodiments of the invention, the slurry is extruded onto a conveyor belt, and the construction board may be formed on the conveyor belt itself.

The method may also comprise a step of injecting the particulized solid material into at least one side of the extruded slurry or injecting into two opposing sides. Such injections may occur simultaneously and produce cross-banded particulized solid material within the construction board.

The construction board may be vacuumed to decrease the time necessary for drying. The particulized solid material may comprise fiber glass particles or be selected from a group consisting of hemp, bamboo, blue stranded grass, corn stalks, and glass beads or be a mixture thereof.

A device for making a construction board may comprise a mixing apparatus for preparation of a slurry comprising magnesium oxide, magnesium chloride, and a binding agent, a funnel operatively connected by at least one inlet to the mixing apparatus and comprising at least one inlet to a vessel comprising particulized solid material, and an extruding tip operatively connected to the funnel for extruding the slurry comprising the particulized solid material.

In embodiments of the invention, slurry exits from the extruding tip onto a conveyor belt, and the construction board may be formed on the conveyor belt. The device of the invention may further comprise a second inlet in the funnel configured to receive particulized solid material into at least one side of said construction board. The side comprising the second inlet may be on the opposing side of the first inlet.

The construction board may be formed comprising cross-banded particulized solid material. The device of the invention may further comprise a vacuum configured for drying said construction board. The particulized solid material in said construction board may be injected or located at pre-designated intervals within said construction board.

### BRIEF DESCRIPTION OF THE DRAWINGS

FIG. 1 shows a perspective view of a device used to carry out embodiments of the invention.

FIG. 2 shows a perspective view of the device of FIG. 1 while in use in embodiments of the invention.

FIG. 3 shows a side view of the device of FIG. 2 magnified to show details of the funnel and inlets for particulized solid materials.

FIG. 4 shows a perspective view of a finished construction board produced in embodiments of the invention.

FIG. 5 shows a detailed view of inset A of FIG. 4 comprising interior particulized solid material and a sparse injection of particulized solid material.

FIG. 6 shows a detailed view of inset A of FIG. 4 comprising interior particulized solid material and a dense injection of particulized solid material.

FIG. 7 shows a detailed view of inset A of FIG. 4 without particulized solid material in the interior portion of a construction board.

### DETAILED DESCRIPTION OF EMBODIMENTS OF THE INVENTION

Embodiments of the invention comprise a method of making a construction board (also known as wallboard), comprising the mixing of at least magnesium oxide, magnesium chloride, and a binding agent into a slurry, adding particulized solid material while funneling the slurry, and extruding the slurry comprising the particulized solid material.

Embodiments of the invention further comprise a device for making a construction board. The device comprises a mixing apparatus for preparation of a slurry. The slurry may be of a type generally known in the prior art for producing magnesium oxide-based boards and is formed by mixing magnesium oxide, magnesium chloride, and at least a binding agent. A funnel is operatively connected to the mixing apparatus and is used to extrude the slurry out into a mold. The funnel may be any device in which the slurry passes through, having a larger input than output during the process of forming a construction board. It may be integrated with the mixing apparatus in one unit or may be a separate unit. The funnel itself has at least one inlet, and in embodiments of the invention, two inlets (such as one on each side) for receiving particulized solid material from a vessel, such as a holding chamber or two holding chambers. An extruding tip is operatively connected at the outlet of the funnel, may form a unitary structure with the funnel, and is used for extruding the slurry comprising the particulized solid material.

The particulized solid material may be injected on one or both sides of the slurry and may be cross-banded (i.e., overlapping when viewed from an elongate surface) in the finished construction board. The cross-banding significantly improves the strength of the construction board, and a finished product produced in a device of the invention should meet the ASTM requirements for the nail pull resistance tests described in “Background of the Invention.”

A particulized solid material is a material comprised of a plurality of individual pieces which may move past one another and are of a relatively small size, such as pieces of natural or synthetic fibers (glass fibers, microfibers, wood fibers), and maintain their physical structure or a part thereof when subject to mixing forces or heat. Such particulized solid materials used in embodiments of the invention may be fiber glass, hemp, bamboo, blue stranded grass, corn stalks, and glass beads or a combination thereof. When using blue stranded grass and other particulized fibers where necessary, the strands are typically pretreated with coatings, laminates, or other materials, so that the physical properties of the blue stranded grass or other materials meet the criteria of a particulized solid material used in embodiments of the invention.

The device and method of the invention will become clearer in view of the following description of the figures.

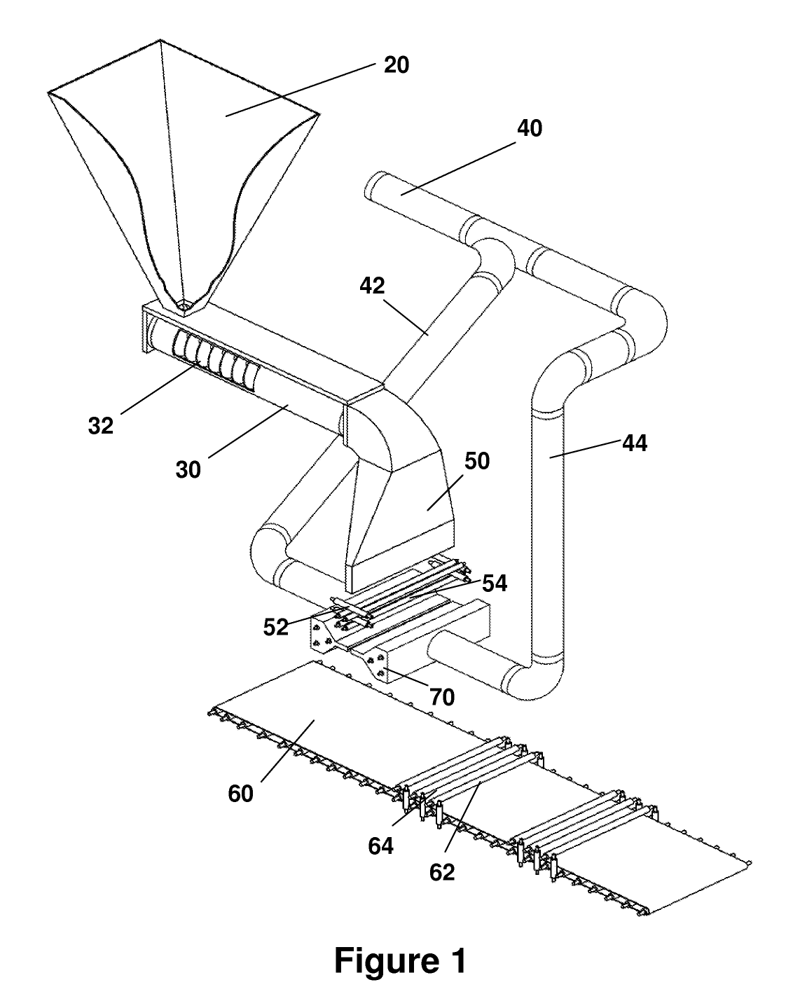

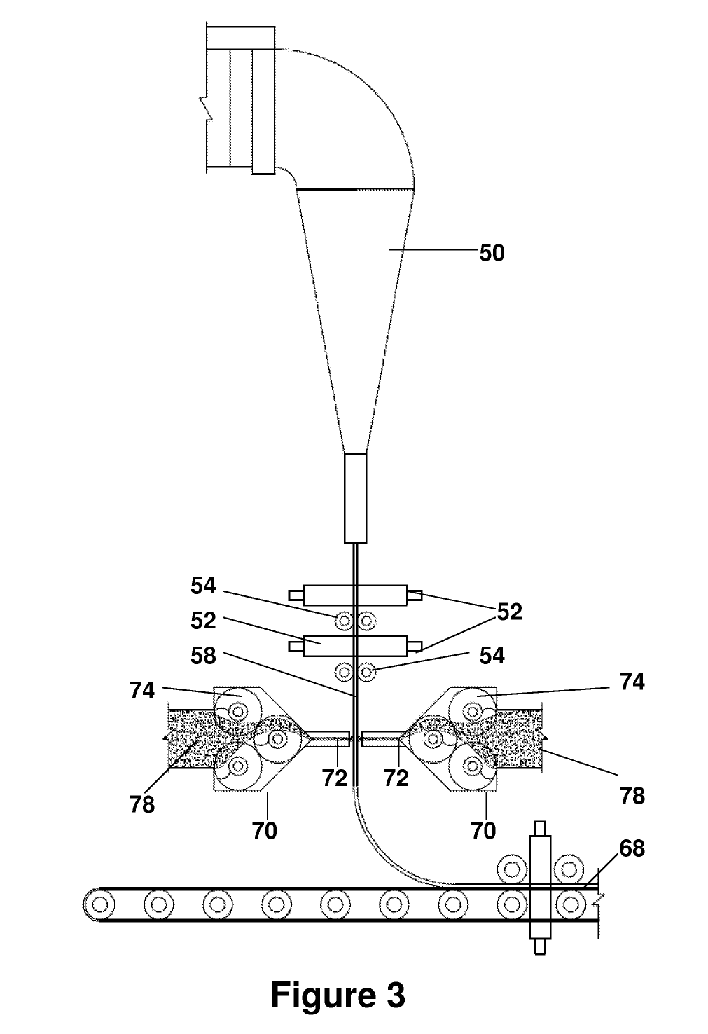

FIG. 1 shows a perspective view of a device used to carry out embodiments of the invention. A mixing apparatus 20 (cutaway version shown) is used to mix the ingredients which react chemically and form the slurry used to produce magnesium oxide construction board. At least magnesium oxide, magnesium chloride, and one binding agent are required at this stage. The mixture may be substantially any mixture known in the art of producing magnesium oxide construction board, and may include water, perlite, structural fibers, fly ash, magnesium silica, and/or mica. In embodiments of the invention, particulate solid material is added to the mixture, so as to allow such material to be interspersed within the resulting construction board. In other embodiments of the invention, particulate solid material is only added through outlets 72 of FIG. 3, as will be described with reference to FIG. 3 below.

In embodiments of the invention, the magnesium oxide comprises, by weight, between 85% and 92% magnesium oxide, depending upon the thickness of the desired resulting construction board, as will be explained below. The magnesium chloride is first diluted in at least as much water as is necessary.

Table 1 illustrates the percentages by weight of the various materials which may be placed into the mixing apparatus 20 in embodiments of the invention:

TABLE 1

| Material | % By Weight |
|---|---|
| Magnesium Oxide | 46-54% |
| Magnesium Chloride with Water | 23-31% |
| Perlite | 2%-15% |
| Binding Agent (i.e. Wood) | 2%-17% |
| Structural Fibers | 3%-6% |
| Fly Ash | 1%-3% |
| Magnesium Silica | 1%-3% |
| Mica | 1%-3% |

The magnesium chloride may be added to the mixing apparatus 20 in a dry (powder) form or first mixed with water. The pre-mixing with water aids in removing impurities. The mixing apparatus 20 may have various speeds and may be used at high speeds when first mixing materials, and then at low speeds during the extrusion process, in order to maintain a proper consistency of the mixture. Materials may also be mixed by hand or pre-mixed before placement in the mixing apparatus 20 and/or be further mixed in causeway 30. The mixing apparatus is a funnel in embodiments of the invention.

Referring again to FIG. 1, causeway 30, which may comprise a rotating corkscrew mixing device 32 or another mechanism known in the art of mixing devices. A combination funnel and extruding tip 50 are operatively connected to the causeway 30 (or may be connected directly to the mixing apparatus 20). The extruding tip 50 may be removable and/or integrated with the funnel portion thereof. The front/rear rollers 54 and side rollers 52 ensure that the extruded slurry stays in a proper track and dimension.

Pipe 40 splits into rear pipe 42 and front pipe 44. Pipes 42 and 44 terminate at respective injectors 70. The pipes 40, 42, and 44 comprise particulate solid material which is injected into at least a front or rear generally flat elongate side of slurry being extruded out of the extruding tip 50. Pipe 42 is used, in an embodiment of the invention, for the rear side, and pipe 44 for the front side. It should be understood by one having skill in the art that any mechanism for holding particulate solid matter and for injecting same into two opposing sides, as described in this paragraph, or any one, two, or more sides of an extruding or extruded slurry, are within the scope and spirit of the present invention.

Conveyor belt 60 is situated beneath the extruding or extruded slurry in such a manner that the slurry falls on to the moving conveyor belt and proceeds under vertical roll bars 64 and horizontal roll bars 62, in order to further shape the forming construction board, as necessary, and aid in the movement of the board.

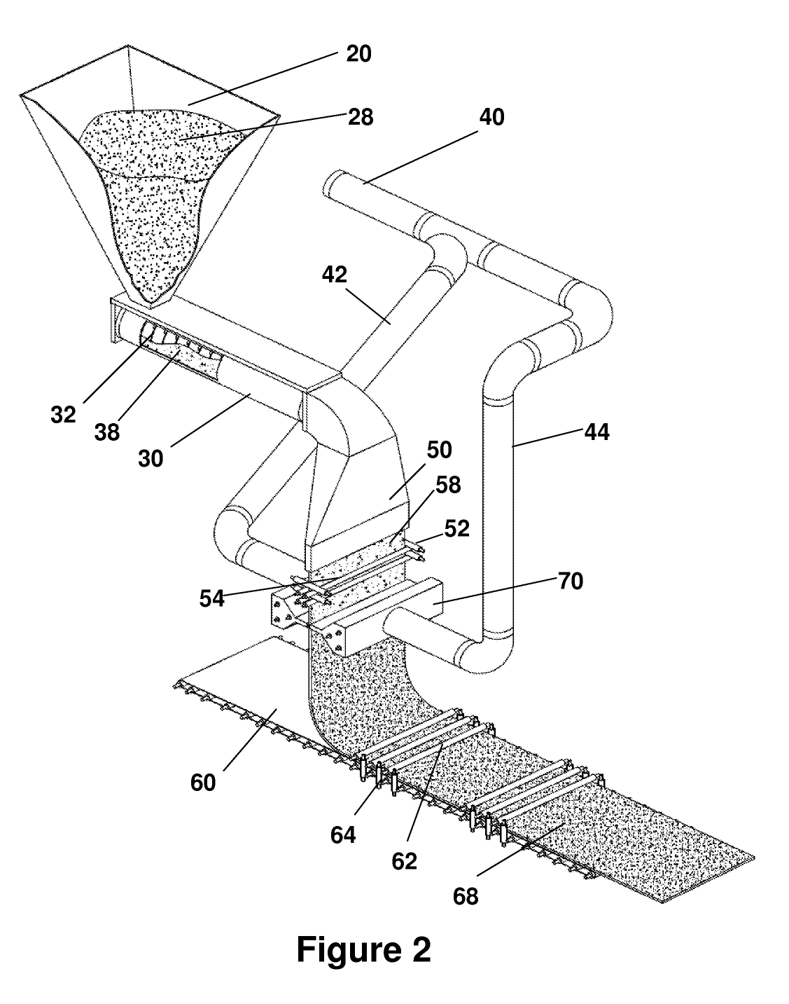

FIG. 2 shows a perspective view of the device of FIG. 1 while in use in embodiments of the invention. The numbering of elements of FIG. 2 is the same as those of FIG. 1, with the addition of elements 28, 38, 58, and 68 which refer to the slurry or construction board at various stages of production.

Mixture 28 is comprised of magnesium oxide, magnesium chloride, and a binding agent, and may also comprise further materials in the percentage ranges described above. Mixture 28 may be pre-mixed, mixed in the mixing apparatus 20, and/or mixed in a spiral chamber 38 or other mixing device within a causeway 30, or between a first vessel and an extruding tip 50. Mixture 28 may be liquid or a mix of liquid and solid, and may be heated and in transition between a liquid and solid form. The transition to a slurry, such as slurry 38, may occur in the mixing apparatus 20 and/or at any point before and during extrusion at the extruding tip 50. The transition into a slurry may comprise a hardening and drying of the slurry into a solid or semi-solid form, but typically completes solidification and hardening after cooling and/or vacuuming of the slurry after reaching the conveyor belt 60 and forming a solidifying construction board 68.

Again, with respect to FIG. 2 and embodiments of the invention in general, it should be noted that particulate solid material is added to the mixing chamber 20 in addition to the injection stage which takes place as the slurry 58 passes an injector 70 in embodiments of the invention. In other embodiments of the invention, particulate solid material (i.e., fiberglass particles) is not added to the mixing apparatus 20. In still further embodiments, one type or grouping of types of particulate solid material may be added to the mixing apparatus 20, while another is injected by injectors 70. If it is desired to use a different type of particulate solid matter on each side of a construction board, then different particulate solid matter may be used in each injector 70.

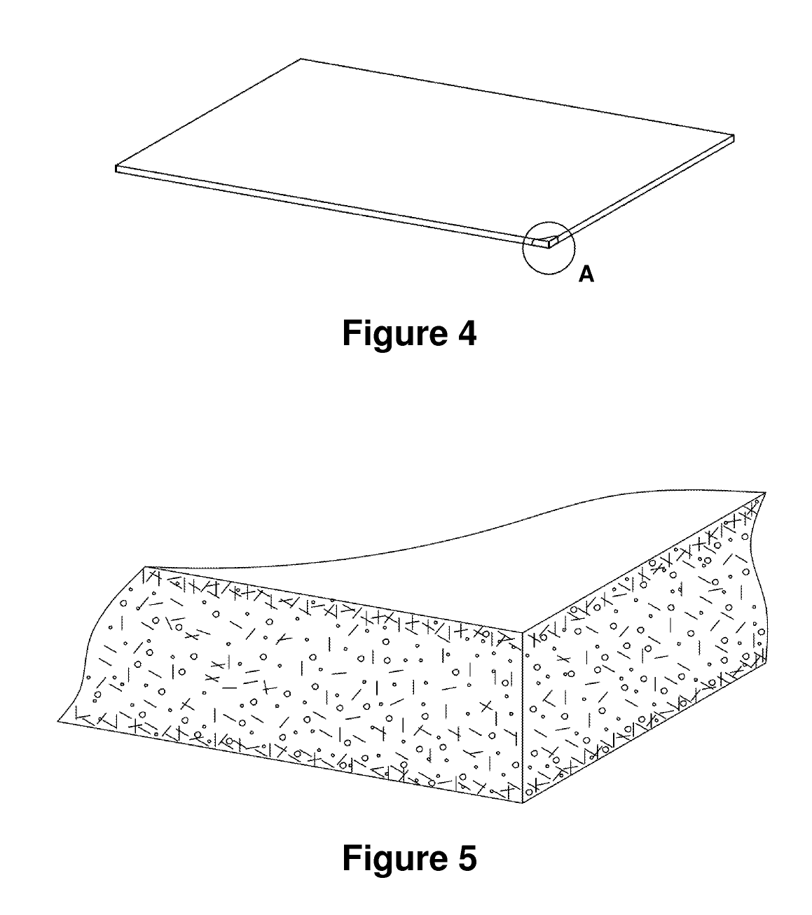

Further, with respect to the slurry 58 versus solidifying construction board 68, slurry 58 is depicted before the step of injection by the injectors 70. While the slurry 58 is being pushed out the extruding tip (such as by adding pressure within the extruding tip 50), approximate dimensions of the resulting construction board are determined by the breath and depth of the extruding tip 50. Thus, when injected with particulized solid material by way of the injectors 70, the particulized solid material may be placed on and near what will be the top and bottom surfaces of the resulting construction board. The injections concentrate the particulate solid material at and near the top and bottom surfaces in embodiments of the invention and allow for cross-banding of the particles which increase the strength of the construction board (see description of FIG. 4 for a description of the dimensions of a construction board). In nail pull resistance tests, the cross-banded particles prevent a nail or other fastener from passing through the finished construction board and, at the time of this writing, are anticipated to meet, or already have met, the ASTM requirements for nail pull resistance in magnesium oxide construction board. In the prior art, solid particulized material, such as fiber glass particles, was placed only in the slurry itself, where it becomes mixed fairly heterogeneously throughout a construction board. Alternatively, fiber glass formed netting on a top or bottom size and could not withstand the forces placed upon it by fasteners.

However, in methods and devices of embodiments of the present invention, by injecting the particles on either side of an extruded slurry, the slurry is already roughly formed (meaning, recognizable to a human observer) into the shape of a construction board in at least one dimension. The fiber glass or other particulate or particulized matter, when injected at such a time, forms on and near the surface of the resulting construction board. This feature prevents damage to the construction board and allows for added strength and ability to hold a fastener and prevent dimpling of the surface. The particulate or particulized material, since it may be placed in large quantities near the surface and will be found in much higher percentages near the surface over the prior art, will cross-band. This means that the particles will overlap each other when viewed from an elongate surface into which the particles have been injected. Thus, if one piece of particulate matter is “pushed” on by a fastener or trauma to the construction board, it will exert force on another piece of particulate matter, which may, in time, exert force on another piece and so forth, dissipating the force of the blow and allowing the construction board to better maintain the desired configuration and be stronger, in that greater forces can be exerted on the board without causing damage.

FIG. 3 shows a side view of the device of FIG. 2 magnified to show details of the funnel and inlets for particulized solid materials. Front/rear rollers 54 guide and may shape the depth of the extruding or extruded slurry 58, in addition to shaping by the extruding tip 50. Side rollers 52 (only one set of side rollers behind the slurry 58 shown for clarity), similarly, guide and may aid in shaping of the slurry 58.

The particulized solid material 78 exits through one or a plurality of outlets 72 positioned on a front and back or first and second side of the extruded slurry 58. The injector housing 70 comprising impellers 74, or any other means known in the art, may be used to aid in controlling the quantity, density, and velocity in which the material 78 exits through the outlets 72. For example, when it is desired to more densely pack particulate material into a resulting construction board, the rate of expulsion of material from the outlet or outlets 72 may be increased (or the rate of extrusion of the slurry 58 from the extruding tip 50 may be decreased). This may be accomplished by adding more outlets 72. Further, if it desired for the particulized material to be placed deeper into the surface of the forming construction board, the velocity of expulsion may be increased by, for example, increasing the speed of the impellers 74.

Depending on the conditions, such as the thickness of the slurry 58 and the thickness of the construction board which will be formed, it may be desired to vary the density of and/or the depth of the particulized matter, in order to maximize the strength of the construction board. For example, panels may range in thickness from about 6 mm (0.23 inches) to about 38 mm (1.5 inches) wide. In a thicker board or panel, a greater depth and/or density of particulized material may be necessary to achieve desired strength. In a thinner board or panel, a lesser depth and/or density may be necessary to achieve the desired strength. To achieve cross-banding of particles and the strengths required for relevant ASTM tests, depth and density of the particles are also factors. Thus, in order to promote proper cross-banding while maintaining the strength of the board itself, it may be necessary to balance the velocity and density of particles expelled from outlet 72 into the slurry 58.

FIG. 4 shows a perspective view of a finished construction board produced in embodiments of the invention. The construction board 68, as shown in FIG. 2, is cut to the desired length and width as it passes on the conveyor belt. In embodiments of the invention, a vacuum is used to increase drying speeds and final preparation of the construction board. The top and bottom sides (relative to the position on the conveyor belt) are typically vacuumed in addition to, or instead of, the prior art method of heating to aid in drying thereof.

As used when describing embodiments of the present invention, the top side refers to the generally flat, elongate and rectangular side dominating the majority of what is shown in FIG. 4. The bottom side refers to the side opposite the top side, and for purposes of embodiments of the invention, the top and bottom sides are interchangeable (thus, only the top shown is shown in the figure). The width of the extruding top 50 determines the approximate width (the distance form corner A to the upper right corner of the drawing, by way of example) of the construction board, though in embodiments of the invention, the construction board may be cut after extruding if another size is desired.

FIG. 5 shows a detailed view of an inset A of FIG. 4 comprising interior particulized solid material and a sparse injection of particulized solid material. In order to achieve such a result, the particulized solid material, i.e., a plurality of fiberglass particles, is added to the slurry in the mixing apparatus 20 and is injected onto either side of the extruded slurry 58.

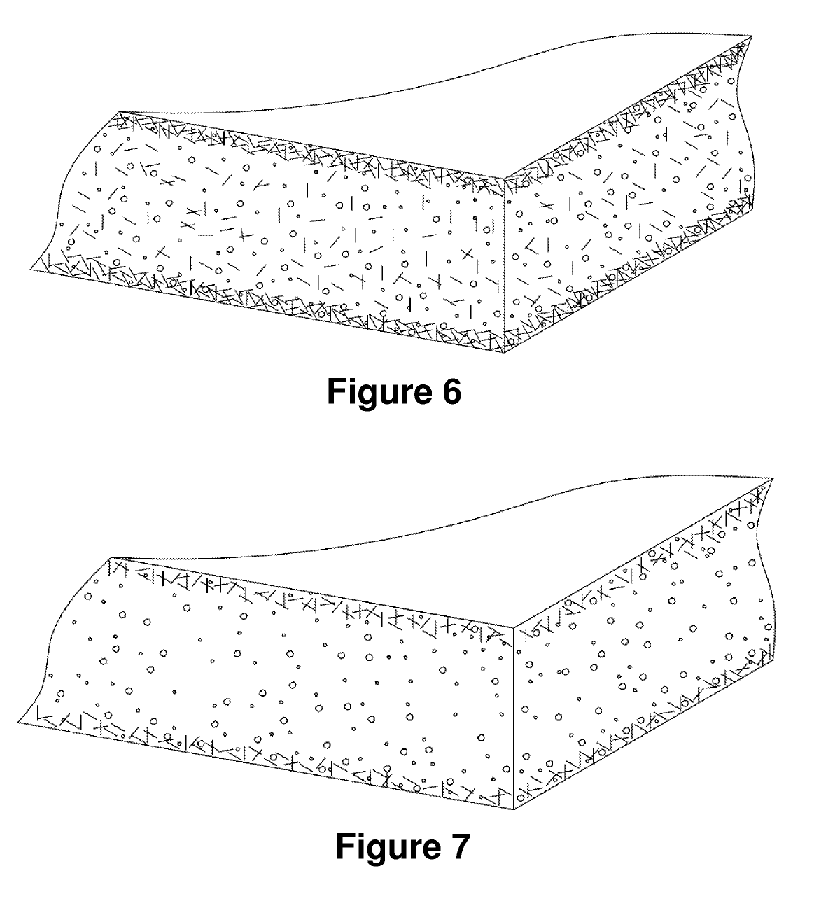

FIG. 6 shows a detailed view of an inset A of FIG. 4, comprising interior particulized solid material and a dense injection of particulized solid material. In order to achieve such a result, the particulized solid material is added to the slurry in greater quantities or with a slow extrusion speed of the slurry 58. In order to achieve such a result, many outlets 72 may be used. The denser the injection of the material, the more cross-banding occurs, and to the extent that the hardened slurry is able to hold the particles, the higher the strength of the surface. Thicker boards, for example 1.5 inch boards, may hold more particulate matter in general and may have 85% magnesium oxide and 15% of various other materials (described above, see Table 1) before the injection of particulate matter. Thinner boards, for example 0.25 inch boards, may hold less particulate matter in general, and may have 92% magnesium oxide with 8% of various other materials before the injection of particulate matter.

FIG. 7 shows a detailed view of an inset A of FIG. 4 without particulized solid material in the interior portion of a construction board. This means that the particulized solid material has only been added to the construction board by way of injection after extruding the slurry 58 from the extrusion tip 50. This may be desired in embodiments of the invention, such as when producing thinner boards where further particulized matter is unnecessary, or where such particulized matter creates difficulty in extrusion. In other embodiments of the invention, the particulate solid matter may aid in the mixing or extrusion process and add to the strength and/or cross-banding of particles in a construction board.

It should also be understood that any one of the embodiments shown, for example, in FIGS. 5-7 may be modified to place the particulized solid material at regular intervals, or more densely at regular intervals. Intervals may be every 5 cm, 10 cm, 20 cm, 0.5 inches, 1 inch, or 2 inches, or as needed in the art of interior walls, such as at edges where the forming boards on the conveyor belt will be cut, and/or where it is anticipated that a fastening device will be driven into the resulting construction board. The purpose of injecting at such intervals or increasing the density or velocity of the injections may also be to increase the strength of a resulting board in general, by allowing more slurry to enter between the intervals.

While the invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

1. A device for making a construction board comprising:
a mixing apparatus for preparation of a slurry comprising magnesium oxide, magnesium chloride, and a binding agent;
a funnel operatively connected by at least one inlet to said mixing apparatus and comprising at least one inlet configured to receive particulized solid material from a vessel; and
an extruding tip operatively connected to said funnel for extruding said slurry comprising said particulized solid material.

2. The device of claim 1, wherein said slurry exits from said extruding tip onto a conveyor belt.

3. The device of claim 2, wherein construction board is formed on said conveyor belt.

4. The device of claim 3, further comprising a second inlet in said funnel configured to receive particulized solid material into at least one side of said construction board.

5. The device of claim 4, wherein said at least one side is an opposing side of said first inlet.

6. The device of claim 4, wherein said construction board comprises cross-banded particulized solid material.

7. The device of claim 1, further comprising a vacuum configured for drying said construction board.

8. The device of claim 1, wherein said particulized solid material in said construction board is located at pre-designated intervals within said construction board.

9. The device of claim 1, wherein said particulized solid material comprises fiber glass particles.

10. The device of claim 1, wherein said particulized solid material is selected from the group consisting of hemp, bamboo, blue stranded grass, corn stalks, and glass beads.

11. Construction board made from a slurry;
said slurry comprising magnesium oxide, magnesium chloride, and a binding agent;
wherein said slurry receives particulized solid material; and
said slurry comprising said particulized solid material is extruded to form said construction board.

12. The construction board of claim 11, wherein said slurry comprising said particulized solid material is extruded onto a conveyor belt.

13. The construction board of claim 12, wherein said construction board is formed on said conveyor belt.

14. The construction board of claim 13, wherein said particulized solid material is placed in at least one side of said construction board.

15. The construction board of claim 14, wherein said at least one side is two sides.

16. The construction board of claim 14, wherein said construction board comprises cross-banded particulized solid material.

17. The construction board of claim 16, wherein said construction board is dried, at least in part, with a vacuum.

18. The construction board of claim 11, wherein said particulized solid material in said construction board is located at pre-designated intervals within said construction board.

19. The construction board of claim 11, wherein said particulized solid material comprises fiber glass particles.

20. The construction board of claim 11, wherein said particulized solid material is selected from the group consisting of hemp, bamboo, blue stranded grass, corn stalks, and glass beads.
